(19) United States
(12) Patent Application Publication
(10) Pub. No.: US 2005/0034274 A1
(43) Pub. Date: Feb. 17, 2005

(54) Hinge

(76) Inventor: Ching Sung Wu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/638,347

(22) Filed: Aug. 12, 2003

(51) Int. Cl. E05D 11/08

(52) U.S. Cl. 16/342

(57) ABSTRACT

A hinge includes a cylinder having a close end and an open end longitudinally opposite to the close end of the cylinder. A polygonal sleeve is fixedly received in the cylinder. The polygonal sleeve has multiple edges abutting against an inner periphery of the cylinder. A pivot axle is partially pivotally received in the sleeve. A sealant is mounted around the pivotally for tightly closing the open end of the cylinder to prevent the lubricant in the hinge from leaking.

### BACKGROUND OF THE INVENTION

1. Field of the Invention

The present invention relates to a hinge, and more particularly to a hinge that can prevent the lubricant from leaking.

2. Description of Related Art

A conventional hinge, usually used to a notebook, in accordance with the prior art shown in FIG. 7 comprises a sleeve (5) and a pivot axle (6) partially pivotally received in the sleeve (5). The sleeve (5) includes a slit (51) defined in an outer periphery of the sleeve (5) and extending through the slit (5) such that the sleeve (5) can be slight shrunk due to the slit (51). A plate (52) longitudinally extends from the sleeve (5) opposite to the pivot axle (6). The plate (52) is adapted to be secured on the notebook. The pivot axle (5) includes a rod (61) centrally and longitudinally extending therefrom opposite to the sleeve (5). The rod (61) is adapted to be secured on a monitor of the notebook. Consequently, the monitor can be circuitously moved relative to a mainframe of the notebook.

With reference to FIGS. 8 and 9, the diameter of the sleeve (5) can be slightly adjusted to promote the friction and adjust the torsion between the sleeve (5) and the pivot axle (6). The inner periphery of the sleeve (5) and the outer periphery of the pivot axle (6) are coated with lubricant (7) for promoting lubricant effect and prevent the pivot axle (6) from being worn. However, the sleeve (5) has two opposite open ends and the pivot axle (6) is partially pivotally received in the sleeve (5) such that the lubricant (7) will leak out of the sleeve (5) from the open ends of the sleeve (5) and the slit (51) in the sleeve (5). The leaking lubricant (7) may evaporate due to a high temperature such that the lubricant effect between the sleeve (5) and the pivot axle (6) is reduced. Furthermore, the leaking lubricant (7) may pollute the notebook.

The present invention has arisen to mitigate and/or obviate the disadvantages of the conventional hinge.

### SUMMARY OF THE INVENTION

The main objective of the present invention is to provide an improved hinge that can prevent the lubricant from leaking.

To achieve the objective, the hinge in accordance with the present invention comprises a cylinder having a close end and an open end longitudinally opposite to the close end of the cylinder. A polygonal sleeve is fixedly received in the cylinder. The polygonal sleeve has multiple edges abutting against an inner periphery of the cylinder. A pivot axle is partially pivotally received in the sleeve. A sealant is mounted around the pivotally for tightly closing the open end of the cylinder to prevent the lubricant in the hinge from leaking.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hinge in accordance wit the present invention;

FIG. 2 is a side plan view in partial section of the hinge of the present invention;

FIG. 3 is a cross-sectional view of the hinge in FIG. 3 along line 3-3;

FIG. 4 is an exploded perspective view of a second embodiment of the hinge of the present invention;

FIG. 5 is an exploded perspective view of a third embodiment of the hinge of the present invention;

FIG. 6 is an exploded perspective view of a fourth embodiment of the hinge of the present invention;

FIG. 7 is an exploded perspective view of a conventional hinge in accordance with the prior art;

FIG. 8 is side plan view in partial section of the conventional hinge; and

FIG. 9 is a cross-sectional view of the conventional hinge in FIG. 2 along line 9-9.

### DETAILED DESCRIPTION OF THE INVENTION

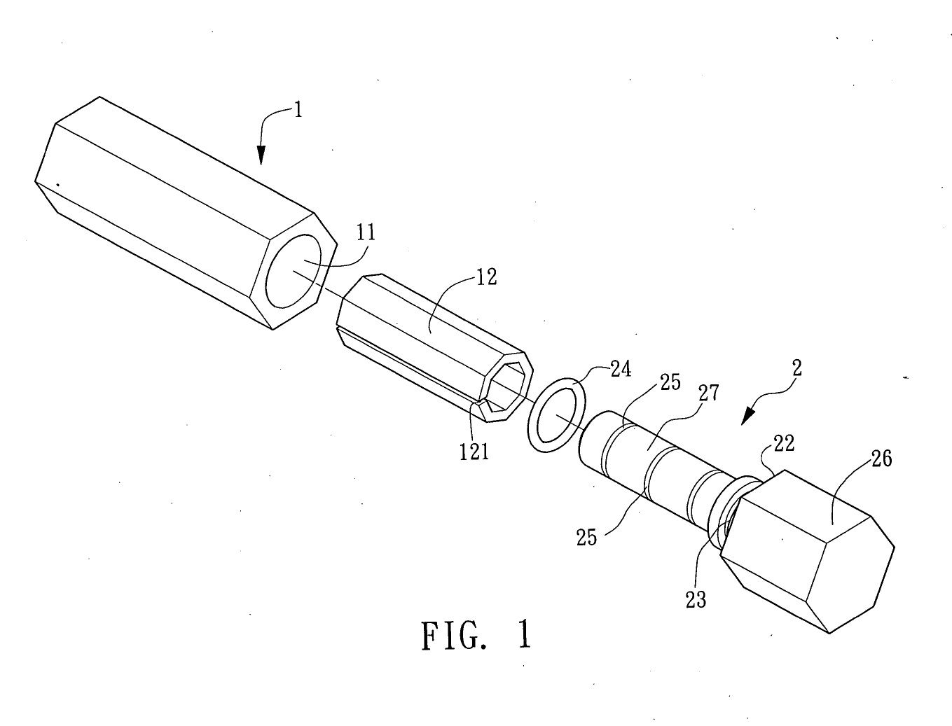

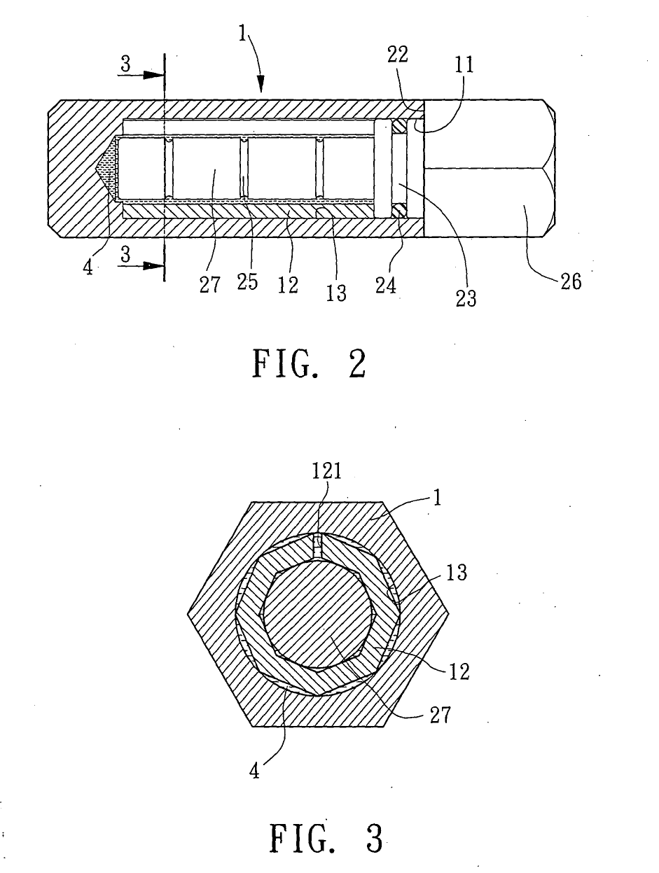

Referring to the drawings and initially to FIGS. 1-3, a hinge in accordance with the present invention comprises a cylinder (1), a sleeve (12) fixedly and fully received in the cylinder (1) and a pivot axle (5) partially pivotally received in the sleeve (12).

The cylinder (1) includes a close end adapted to be secures on an object and an open end longitudinally opposite to the close end of the cylinder (1). The sleeve (12) has a polygonal shape. In the preferred embodiment of the present invention, the sleeve (12) is octagonal. The sleeve (12) has multiple edges abutting an inner periphery (13) of the cylinder (1) due to the pivot axle (2) partially inserted into the sleeve (12). The sleeve (12) has a slit (121) defined in an outer periphery of the sleeve (12) and extending through the sleeve (12). The pivot axle (2) includes an enlarged head (26) adapted to be secured on an object and a shank (27) centrally longitudinally extending from the enlarged head (26). The shank (27) is pivotally received in the sleeve (12) to expand the sleeve to abut against the inner periphery (13) of the cylinder (1). The shank (27) has a diameter smaller than that of the enlarged head (26) such that a shoulder (22) is formed between the enlarged head and the shank (27). The shoulder (22) abuts the open end (11) of the cylinder (1) when the pivot axle (2) pivotally mounted to the cylinder (1). An annular groove (23) is defined in the shank (27) near the enlarged head (26) for receiving a sealant (24) that rotatably abuts the inner periphery (13) of the cylinder (1). In the preferred embodiment of the present invention, the sealant (24) is an O-ring. The shank (27) has multiple grooves (25) defined therein and communicating with the slit (121) in the sleeve (12). A gap (not numbered) is defined among cylinder (1), the sleeve (12) and the shank (27) for containing lubricant (4) among the cylinder (1), the sleeve (12) and the shank (27) because the sleeve (12) is polygonal. The sealant (24) can prevent the lubricant (4) from leaking from the hinge in accordance with the present invention. Consequently, the lubricant effect of the hinge is ensured.

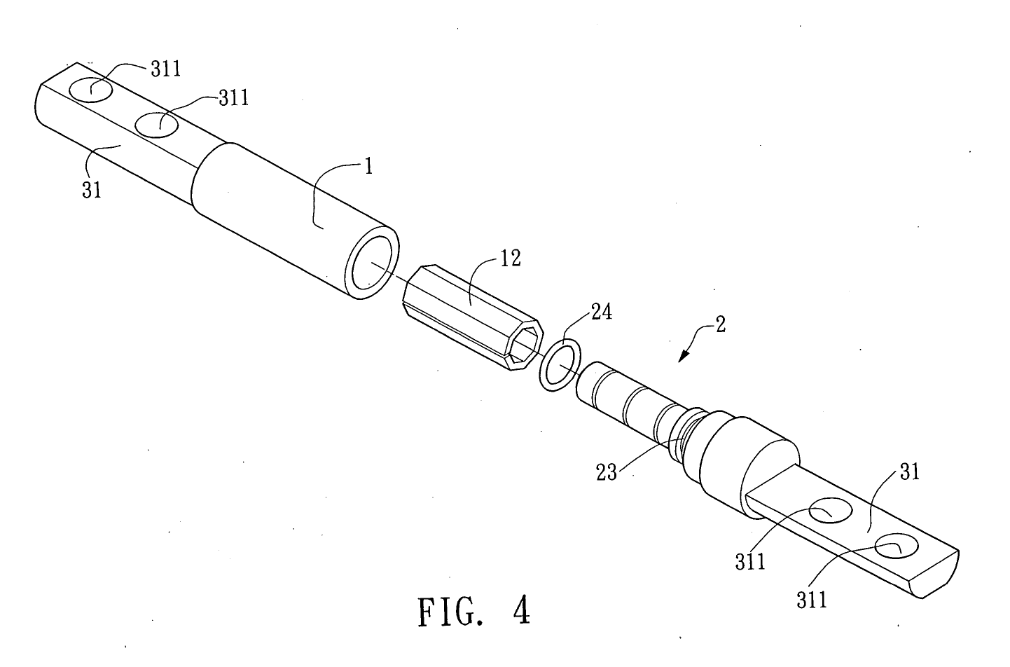

With reference to FIG. 4, the cylinder (1) and the pivot axle (2) each has a protrusion (31) longitudinally extending therefrom. The two protrusions (31) are opposite to each other and each has at least one aperture (311) for easily mounting the cylinder (1) and the pivot axle (2) to a corresponding object.

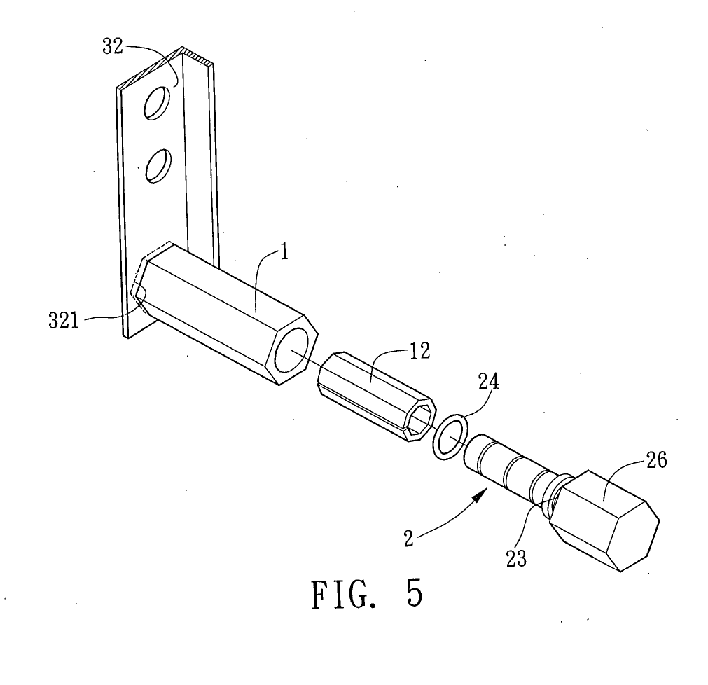

With reference to FIG. 5, the hinge of the present invention further comprises a plate (32) perpendicularly attached to the cylinder (1). The plate (32) has a through hole (321) defined therein for securely receiving the close end of the cylinder (1).

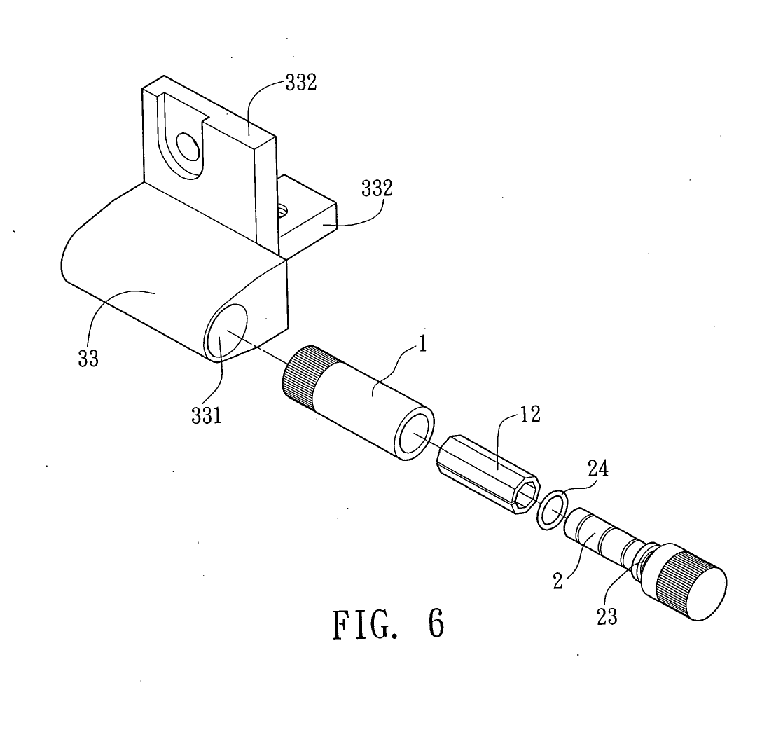

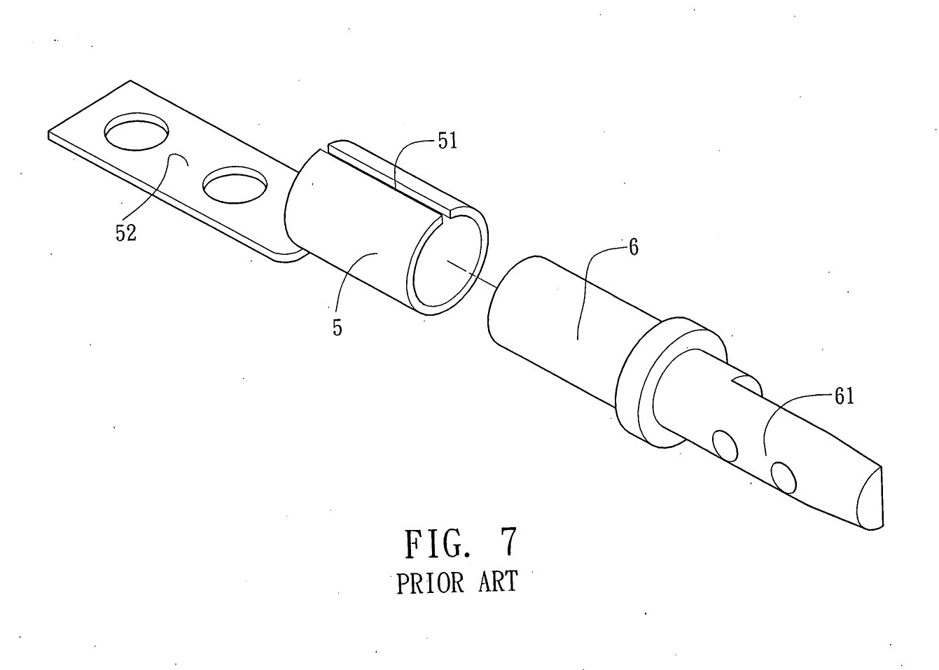

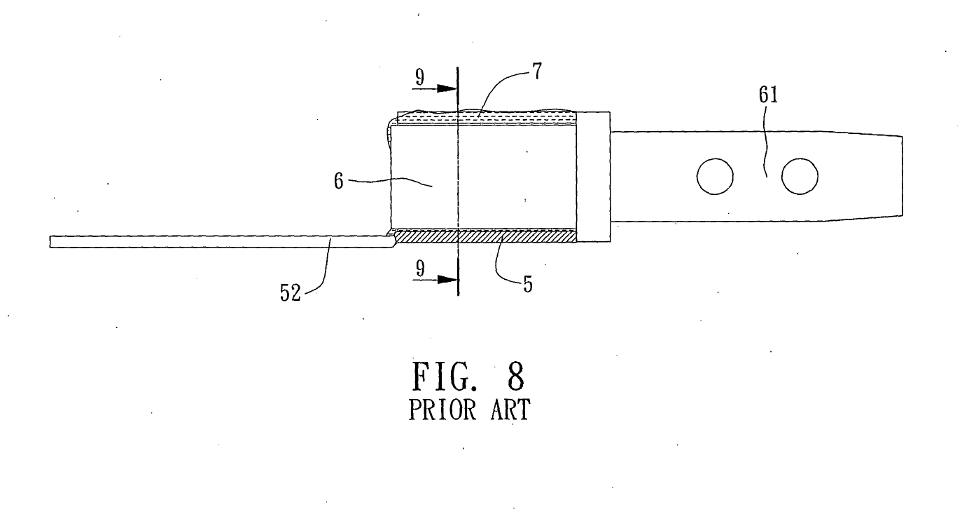

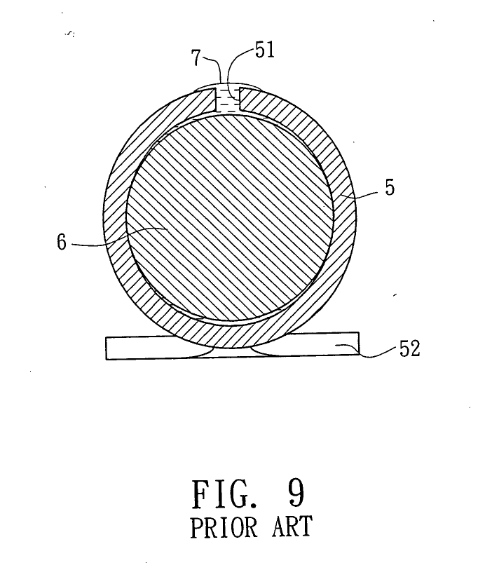

With reference to FIG. 6, the hinge of the present invention further comprises a connecting seat (33) longitudinally mounted to the close end of the cylinder (1). The connecting seat (33) includes a hole (331) defined to securely receive the close end of the cylinder (1) and at least one wing plate (332) extending from the connecting seat (33). The wing plate (332) is adapted to easily mount the connecting seat and the cylinder to an object.

Although the invention has been explained in relation to its preferred embodiment, it is to be understood that many other possible modifications and variations can be made without departing from the spirit and scope of the invention as hereinafter claimed.

1. A hinge comprising:
a cylinder having a close end and an open end longitudinally opposite to the close end of the cylinder;
a polygonal sleeve fixedly received in the cylinder, the polygonal sleeve having multiple edges abutting against an inner periphery of the cylinder; and
a pivot axle partially pivotally received in the sleeve, a sealant mounted around the pivotally for tightly closing the open end of the cylinder.

2. The hinge as claimed in claim 1, wherein the sleeve is octagonal and has a slit defined therein, the slit radially extending through the sleeve such that the sleeve and be slightly radially shrunk.

3. The hinge as claimed in claim 1, wherein the pivot axle comprises an enlarged head and a shank centrally longitudinally extending from the enlarged head, the shank having a diameter smaller than that of the enlarged head such that a shoulder is formed between the shank and the enlarged head, the shoulder abutting the open end of he cylinder when the pivot axle pivotally mounted to the cylinder, an annular groove defined in the shank near the enlarged head for receiving the sealant.

4. The hinge as claimed in claim 3, wherein the sealant is an O-ring.

5. The hinge as claimed in claim 1, wherein the cylinder and the pivot axle each has a protrusion longitudinally extending therefrom, the two protrusions opposite to each other and each having at least one aperture for easily mounting the cylinder and the pivot axle to a corresponding object.

6. The hinge as claimed in claim 1 further comprising a plate perpendicularly attached to the cylinder, the plate having a through hole defined therein for securely receiving the close end of the cylinder.

7. The hinge as claimed in claim 1, wherein further comprising a connecting seat longitudinally mounted to the close end of the cylinder, the connecting seat including a hole defined to securely receive the close end of the cylinder and at least one wing plate extending from the connecting seat, the wing plate adapted to easily mount the connecting seat and the cylinder to an object.
